(19) United States
(12) Patent Application Publication
(10) Pub. No.: US 2007/0089942 A1
(43) Pub. Date: Apr. 26, 2007

(54) Disc brake assembly

(76) Inventors: Fred L. Baldwin, Indianapolis, IN (US); Timothy E. Wilson, Indianapolis, IN (US)

Correspondence Address: INDIANO VAUGHAN LLP., SUITE 850, ONE NORTH PENNSYLVANIA STREET, INDIANAPOLIS, IN, 46204, US

(21) Appl. No.: 11/528,766

(22) Filed: Sep. 28, 2006

Related U.S. Application Data
(60) Provisional application No. 60/721,119, filed on Sep. 28, 2005.

(51) Int. Cl. F16D 65/00

(52) U.S. Cl. 188/73.1

(57) ABSTRACT

A disc brake assembly for a vehicle having a caliper mounted to a non-rotating structure of the vehicle and a housing mounted to a rotating structure of the vehicle fixedly connected to a rotor within the housing. A pressure plate and a pair of annular brake discs on each side of the rotor and extending parallel to the rotor are disposed within the housing and mounted to the caliper for axial movement into the pressure plate. At least one annular brake disc is axially moveable by a hydraulically or pneumatically urged annular piston disposed in caliper.

### I. CROSS-REFERENCE TO RELATED APPLICATION

This U.S. non-provisional patent application claims the benefit of and/or priority to U.S. provisional patent application Ser. No. 60/721,119 filed Sep. 28, 2005 entitled “360 Brake”, the entire contents of which is specifically incorporated herein by reference.

### II. FIELD OF THE INVENTION

The present invention relates to a vehicle brake assembly, and more particularly to a disc brake suitable for two wheeled vehicles such as motorcycles.

### III. BACKGROUND OF THE INVENTION

Disc brakes are commonly used on all types of vehicles, including two wheeled vehicles such as motorcycles. Disc brake assemblies typically include a disc or rotor rotatably mounted to a wheel, with a caliper positioned adjacent to the rotor and capable of clamping friction elements onto the rotor to slow down the rotation of the associated wheel.

Motorcycle brakes are designed so that they are smaller than passenger car disc brakes in part because the smaller size brakes can provide sufficient stopping capability for a motorcycle. Generally, a smaller, lighter, and simpler disc brake is desirable for motorcycles as each of these characteristics generally will lead to better handling of the motorcycle, reduced stopping distance for the motorcycles, improved performance of the brake, ease of manufacturing of the brake, and reduced costs for manufacturing, service, and maintenance of the brakes.

Motorcycle brakes are exposed to view in comparison to brakes of other vehicles such as cars or trucks where the brake assemblies may be partially or completely obscured from view by the associated wheel. Thus, in the case of motorcycles an aesthetically pleasing design for the disc brake is considered desirable.

On motorcycles and other wheeled vehicles, many enthusiasts will personalize their vehicles with custom wheels. Typical motorcycle disc brake assemblies tend to obscure at least some of the aesthetically pleasing aspects of such custom wheels because of the relatively large diameter of the disc rotors; this is considered undesirable by many motorcycle enthusiasts. Some motorcyclists will omit a disc brake assembly altogether from the front wheel so as to provide an unobscured view of the custom wheel. This practice can greatly increase the stopping distance for a motorcycle and for that reason reduce safety and increase the probability of an accident. Thus, a smaller disc brake that performs as well or better than current disc brakes but which does not obscure the view of the wheels is considered desirable by many enthusiasts.

In the case of other wheeled vehicles such as cars and trucks, enthusiasts will also personalize their vehicles with spoked or slotted custom wheels, or other types of wheels with openings through which disc brakes for the associated wheel can be seen. For those enthusiasts that consider this view of the disc brake through the wheel undesirable, a smaller disc brake would be preferable.

In available motorcycle disc brake systems, the friction elements are quite limited in their contact area with the brake rotor. A typical motorcycle disk brake assembly has a caliper and piston combination that clamp a pair of friction elements onto a limited area on opposing sides of a brake rotor.

By increasing the contact area of the friction elements so that there is full annular contact with the brake rotor, the rotor diameter and therefore the diameter of the disc brake assembly can be decreased, while maintaining or improving the braking capabilities of the disc brake assembly.

Full annular disc brake assemblies are known in prior art. For example, U.S. Pat. No. 4,102,438 to Rancourt discloses a full annular disc brake assembly for vehicles such as trucks, tractor-trailers, and the like. U.S. Pat. No. 6,397,982 to Rancourt also discloses a full annular disc brake assembly for a vehicle. However, these patents disclose complex means to actuate and to cool the disc brake.

As far as is known to the applicants, there are no commercially available disc brake systems with large contact area annular friction elements that do not substantially obscure the view of a motorcycle wheel or which are substantially hidden from view when viewed through slotted or spoked vehicle wheels and yet accomplish efficient cooling and enjoy simplicity and low cost of construction, maintenance, and repair.

Therefore, an object of this invention is to design a large contact area annular disc brake assembly for vehicles such as motorcycles which does not substantionally obscure the view of the vehicle wheel.

Another object of this invention is to design a large contact area disc brake that is less complicated than prior art large contact area disc brakes.

Still another object of the invention is to design a large contact area disc brake which dissipates the heat generated during braking.

Another object of this invention to design a disc brake assembly that is aesthetically pleasing.

### IV. SUMMARY OF THE INVENTION

This invention related to a disc brake assembly designed for two wheel vehicles like motorcycles but equally useful in other vehicles such as cars, trucks, and aircraft, which accomplishes the objects set forth above, as well as numerous other and related objects.

A generally cylindrical housing is rotatably connected to a vehicle wheel at a desired location, coaxial with the associated wheel. The housing has air outlets around its circumferential surface. A rotor is centrally disposed within the housing and is rotatably connected to the vehicle wheel. The rotor is axially slidably mounted between a pair of brake discs. Two brake discs are mounted on opposite sides of the rotor and are mounted for axial movement toward and away from the respective surfaces of the rotor.

Movement of the brake discs and rotor is accomplished by fluid pressure acting on an annular piston disposed within a caliper, which is fixedly mounted to a non-rotating structure of the vehicle. Actuation of the annular piston may be hydraulic or pneumatic.

A reaction force to the actuating force of the annular piston is provided by a pressure plate fixedly and non-rotatably mounted to the caliper. The pressure plate and caliper are fixedly connected by bolts and spaces, thereby defining the space for the rotor and brake discs.

The housing includes a plurality of vent holes to allow heated air to escape from the assembly when in operation. The pressure plate, rotor, and brake discs also each include a plurality of slots or holes to allow heated air and brake debris to escape from the space defined by the pressure plate and caliper.

These features of the present invention, as well as numerous possible alterations and modifications will be understood when reference is made to the following description of the preferred embodiment taken in conjunction with the accompanying drawings. The embodiment described is exemplary and not intended to limit the spirit and scope of the invention.

### V. BRIEF DESCRIPTION OF THE DRAWINGS

FIG. 1 is a perspective view of the disc brake assembly as seen mounted on a motorcycle front wheel

FIG. 2 is an exploded perspective view of the disc brake assembly

FIG. 3 is an exploded perspective sectional view of the disc brake assembly substantially through line 3-3 of FIG. 2

FIG. 4 is a side view of the exploded sectional side view of the disc brake assembly of FIG. 3

FIG. 5 is an enlarged sectional side view of FIG. 4 with the disc brake assembled and in the engaged position

FIG. 6 is an enlarged sectional side view of FIG. 4 with the disc brake assembled and in the disengaged position

FIG. 7 is a view of the outer surface of the caliper

FIG. 8 is a view of the inner surface of the caliper

FIG. 9 is a side view of caliper substantially through line 9-9 of FIG. 8

FIG. 10 is an enlarged sectional view of detail 10 of FIG. 9 showing the caliper channel

FIG. 11 is a side view of the caliper viewing the inlet port

FIG. 12 is a sectional side view of the caliper substantially through section 12-12 of FIG. 11

FIG. 13 is a side view of the caliper viewing the bleed port

FIG. 14 is a sectional side view of the caliper substantially through section 14-14 of FIG. 13

FIG. 15 is a view of the inner wall of the annular piston

FIG. 16 is a side view of the annular piston

FIG. 17 is a view of the outer wall of the annular piston

FIG. 18 is a sectional view of the annular piston through section 18-18 of FIG. 17

FIG. 19 is a view of the outer surface of the pressure plate

FIG. 20 is a sectional side view of pressure plate through line 20-20 of FIG. 19

FIG. 21 is a sectional side view of pressure plate through line 21-21 of FIG. 19

FIG. 22 is a view of the backing plate of the brake disc

FIG. 23 is a side view of the brake disc

FIG. 24 is a view of the planar friction surface of the brake disc

FIG. 25 is a view of one planar surface of the rotor

FIG. 26 is a side view of rotor

FIG. 27 is a view of the second planar surface of the rotor

FIG. 28 is a view of the outer surface of the rotor hat

FIG. 29 is a sectional view of the rotor hat substantially through line 29-29 of FIG. 28

FIG. 30 is a view of the inner surface of the rotor hat

FIG. 31 is a side view of the rotor hat

FIG. 32 is a sectional view of the rotor hat substantially through line 32-32 of FIG. 31

FIG. 33 is a sectional view of the rotor hat substantially through line 33-33 of FIG. 31

FIG. 34 is a perspective view of the bearing

FIG. 35 is a side view of the bearing

FIG. 36 is a sectional view of the bearing through line 36-36 of FIG. 35

FIG. 37 is a side view of an adapter sleeve

FIG. 38 is a top view of an adapter sleeve

FIG. 39 is a sectional view of the adapter sleeve substantially through line 39-39 of FIG. 37

FIG. 40 is a perspective view of a bolt

FIG. 41 is a perspective view of a spacer

FIG. 42 is a perspective view of a drive pin

FIG. 43 is a perspective view of a caliper spacer

### VI. DETAILED DESCRIPTION OF THE PREFERRED EMBODIMENT

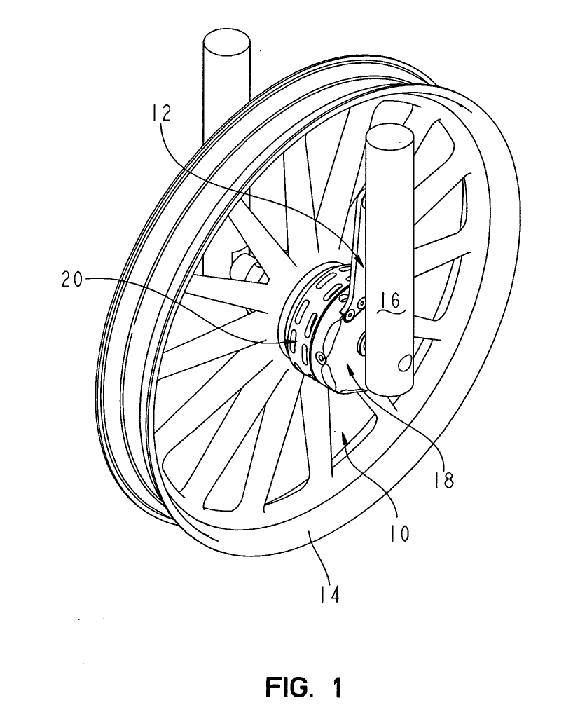

Referring to FIG. 1, the inventive disc brake assembly 10 includes a caliper 18 fixedly mounted to a vehicle with torque arm 12, such as to the motorcycle fork tube 16 shown, and a rotor hat 20 fixedly mounted to the wheel of a vehicle, such as to the motorcycle wheel 14 shown. As those skilled in the art will appreciate, the inventive disc brake assembly 10 can be adapted for use with other types of vehicles with rotor hat 20 fixedly mounted to the wheel, live axle, or hub of such other vehicle and the caliper 18 fixedly mounted to a non-rotating structure of such other vehicle.

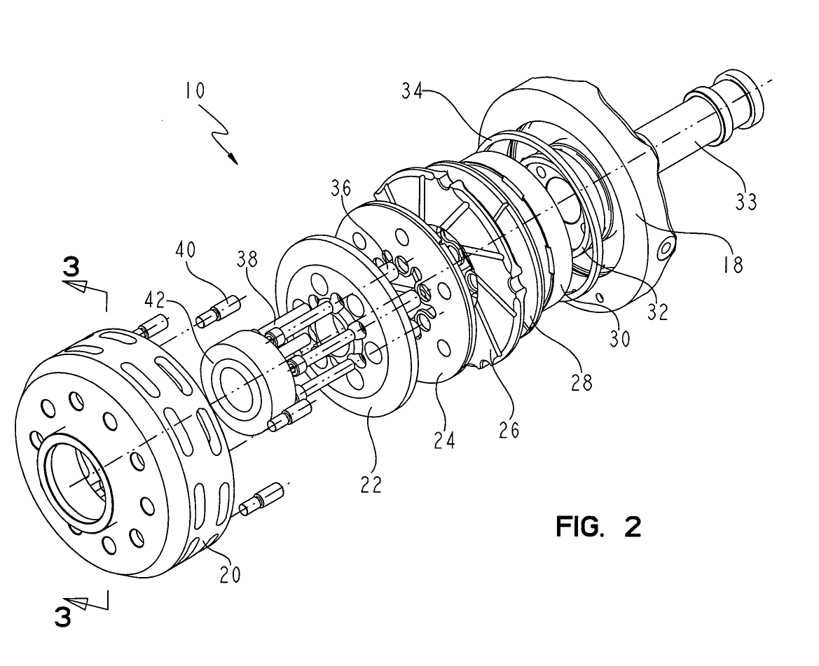

Referring to FIGS. 2 to 5, the rotor hat 20 is concentric with and houses, a pressure plate 22, brake rotor 26 and a pair of brake discs 24 and 28, all of which are axially aligned. The pressure plate 22 and the caliper 18 are maintained in spaced relation by a plurality of fasteners, such as bolts 38 and an equal number of spacer sleeves 36. The brake rotor 26 and brake discs 24 and 28 are axially slidably mounted between the caliper 18 and the pressure plate 22 on spacer sleeves 36. Axial movement of the rotor 26 and brake discs 24 and 28 is achieved by an annular piston 30 housed in caliper 18. The annular piston 30 is actuated by fluid such as compressed air from an air pump (not shown) or hydraulic fluid from a master cylinder (not shown).

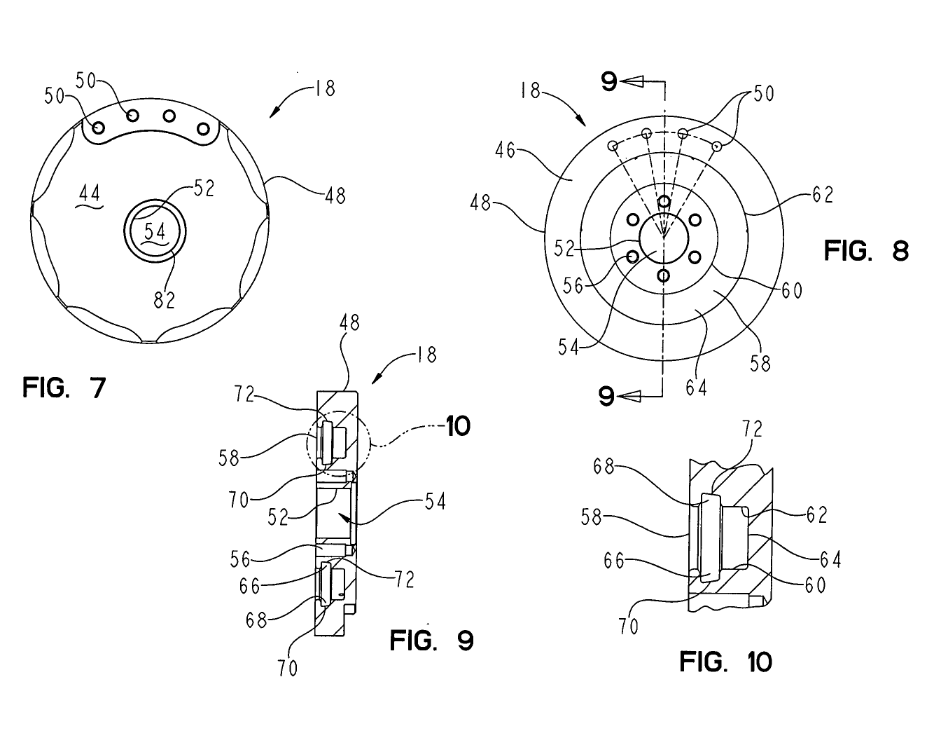

Referring now to FIGS. 7 and 8, the caliper 18 is generally disc shaped with an outer surface 44, an inner surface 46, and an outer circumferential perimetral wall 48. The caliper outer surface 44 includes one or more threaded bores 50 which can extend through to the caliper inner surface 46 for fixedly attaching the caliper 18 to the torque arm 12. As shown in FIG. 9, the caliper also includes an inner circumferential perimetral wall 52 which defines central aperture 54.

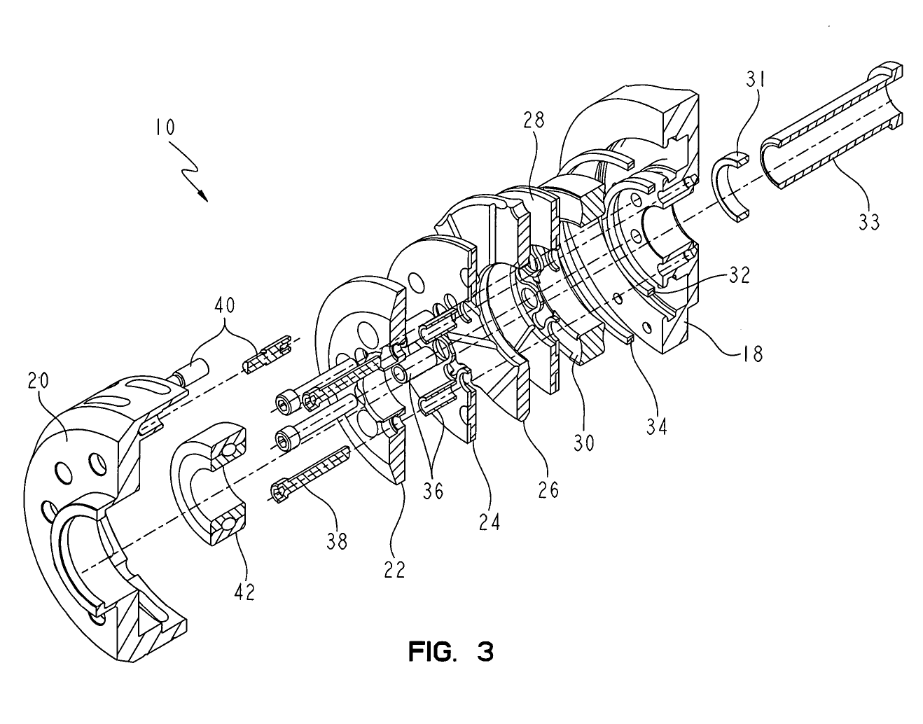

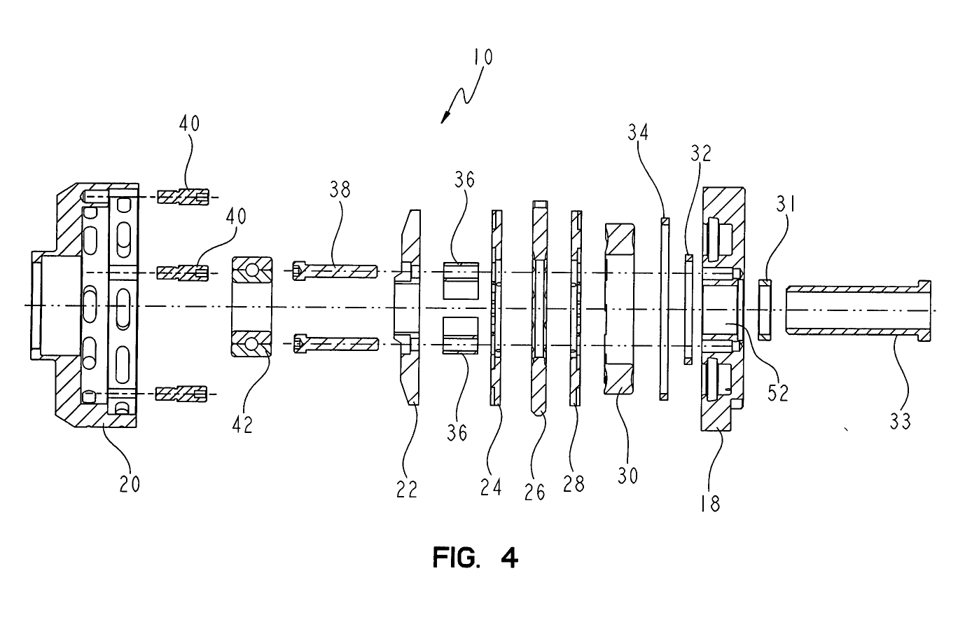

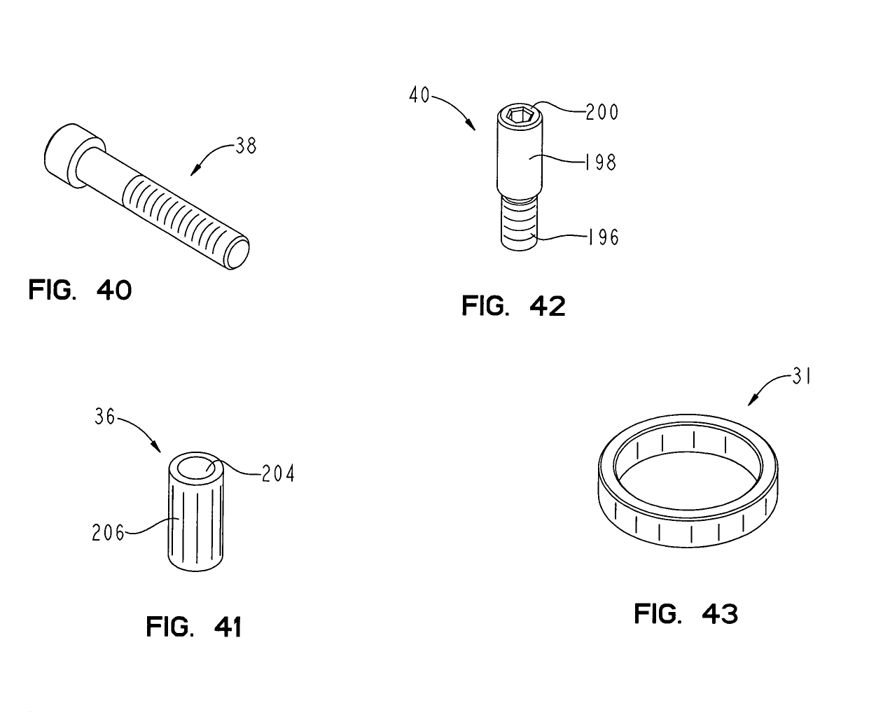

Referring back to FIG. 8, radially outward from and concentric with the caliper central aperture 54 are a plurality of circumferentially spaced threaded bores 56 for receiving fasteners such as bolts 38 (FIGS. 1 and 40) for fixedly attaching the pressure plate 22 to the caliper 18. Radially outward from the circumferentially spaced threaded bores 56 and concentric with the central aperture 54 is an annular channel 58 for receiving annular piston 30. As shown in FIG. 10, the annular channel 58 is defined by circumferential inner wall 60, circumferential outer wall 62, and side wall 64. The inner wall 60 and the outer wall 62 of the annular channel 58 include inner groove 66 and outer groove 68, respectively, for receiving inner seal ring 32 and outer seal ring 34 (FIG. 3). Inner groove 66 includes wall 70 which is preferably angled 10° to 15° from a line parallel to the axis of the disc brake assembly 10 (FIG. 4) so that inner groove 66 is deeper on the left as viewed in FIG. 10. Similarly, outer groove 68 includes wall 72 which is preferably angled 10° to 15° from a line parallel to the axis of the disc brake assembly 10 so that groove 72 is deeper on the left as viewed in FIG. 10. As will be more fully described later, the grooves 66 and 68 and seal rings 32 and 34 (FIG. 3) cooperate to serve as a return mechanism for annular piston 30 disposed within the channel 58.

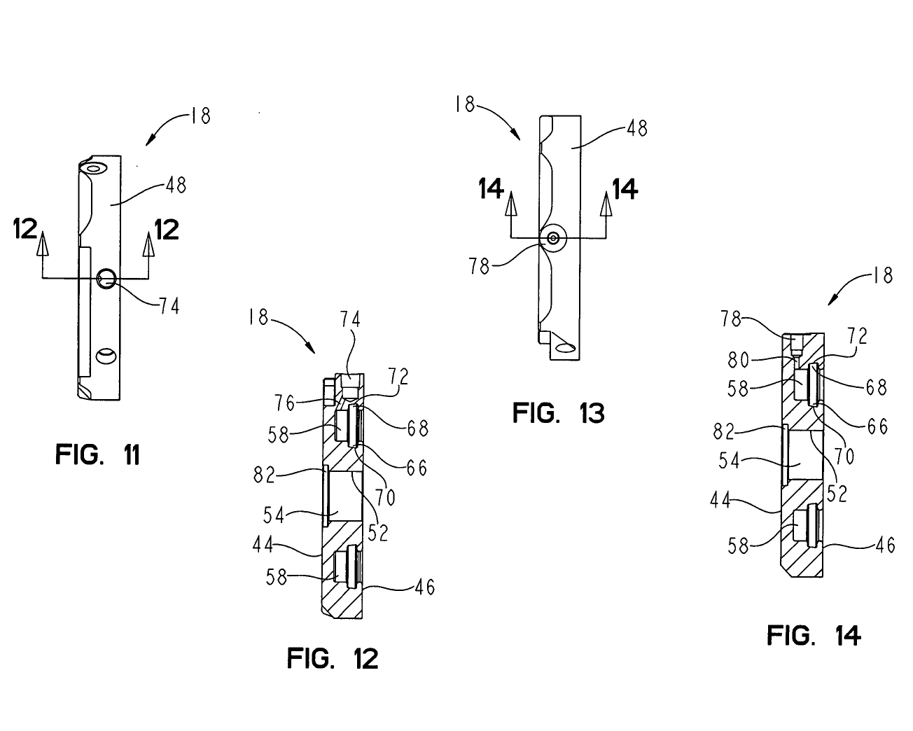

FIG. 11 is a side view of the caliper 18 showing inlet port 74. Inlet port 74 communicates with the caliper annular channel 58 by passageway 76, as shown in FIG. 12 and FIG. 13 is a side view of caliper 18 showing bleed port 78. As shown in FIG. 14, bleed port 78 communicates with caliper annular channel 58 by passageway 80.

As shown in FIGS. 7, 12, and 14, caliper outer surface 44 also includes a circular recess 82 for receiving a caliper spacer (FIG. 43) or adapter sleeve 33 (FIG. 42).

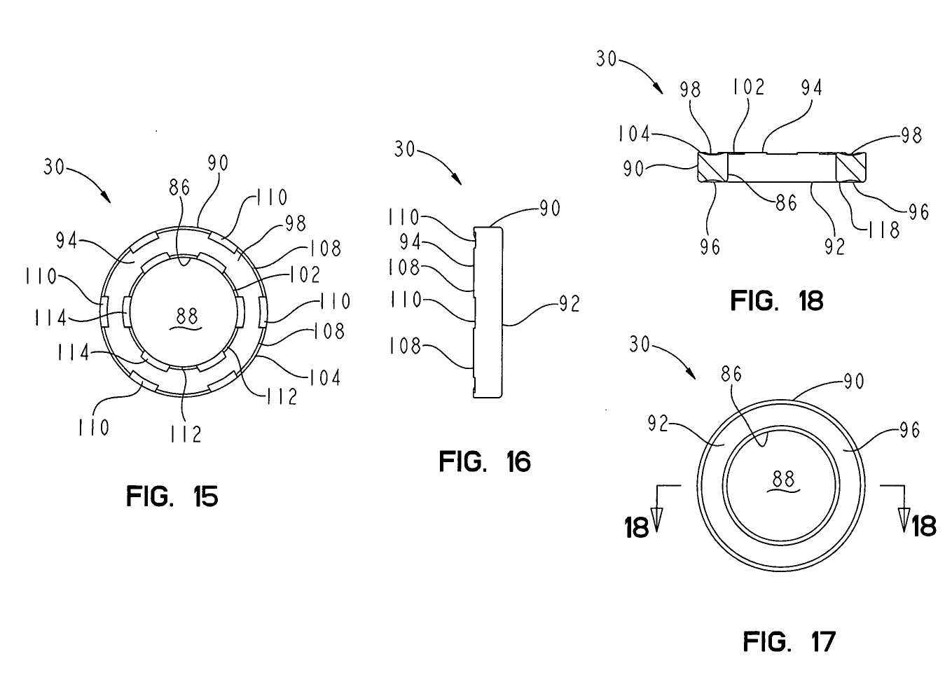

As shown in FIGS. 15 to 18, the annular piston 30 has an axially extending inner wall 86 defining central aperture 88, a concentric axially extending outer wall 90, and a pair of radially extending side walls 92 and 94.

The annular piston outer side wall 92 is disposed within caliper annular channel 58 when the annular piston 30 is assembled into the caliper annular channel 58 (FIG. 5).

As shown in FIG. 18, the annular piston outer side wall 92 and inner side wall 94 include troughs 96 and 98, respectively. Referring now to FIG. 5, it is seen that annular piston outer side wall 92, the caliper annular channel inner wall 60, the caliper annular channel outer wall 62, and the caliper annular channel side wall 64 cooperate to form chamber 100 for receiving fluid such as hydraulic fluid or air for axial movement of annular piston 30 relative to the caliper 18.

Returning to FIGS. 15, 16, and 18, the annular piston inner wall trough 98 includes a radially inboard circumferential raised portion 102 and a radially outboard circumferential raised portion 104. Raised portions 102 and 104 each include a plurality of protrusions 108 and 112, respectively, defining intermediate notches 110 and 114, respectively, which are preferably formed by milling or machining.

As shown in FIG. 5, when the annular piston outer side wall 94 is pressed against the backing plate 134 of a brake disc 28, the inboard protrusions 112 and outboard protrusions 108 contact the brake disc backing plate 134. By limiting the surface area of contact of the annular piston outer side wall 94 with brake disc braking plate 134 to that of the surface area of protrusions 112 and 108, heat transfer from the brake disc backing plate 134 to the annular piston 30, and thus to the fluid disposed in caliper chamber 100, is minimized when the disc brake assembly 10 is in operation.

Inlet port 74 communicates with chamber 100 via passage way 76 so that fluid may ingress and egress chamber 100. Bleed port 78 communicates with chamber 100 via passageway 80 so that air may be bled from chamber 100 when a liquid such as hydraulic fluid is used to pressurize chamber 100.

As can be seen in FIG. 5, fluid is sealed into chamber 100 by means of inner seal ring 32 and outer seal ring 34 which reside in caliper inner groove 66 and outer groove 68, respectively. In the preferred embodiment, the inner seal ring 32 is a Parker Hannifin part number GR-06-002-1 made from compound EB 153-75 with a 1.991 inch inside diameter, and a 0.134 inch wall that is 0.154 inch in thickness. The outer seal ring 34 is Parker Hannifin part number GR-06-003-1 with a 3.473 inch inside diameter and a 0.134 inch wall that is 0.154 inch in thickness. The seal rings are made of resilient and deformable matter and are pre-compressed when the annular piston 30 is installed into the caliper annular channel 58. As caliper 30 is displaced leftward as shown in, energy is stored in seal rings 32 and 34 which is released and returns the annular piston 30 to the right when fluid pressure is released from chamber 30.

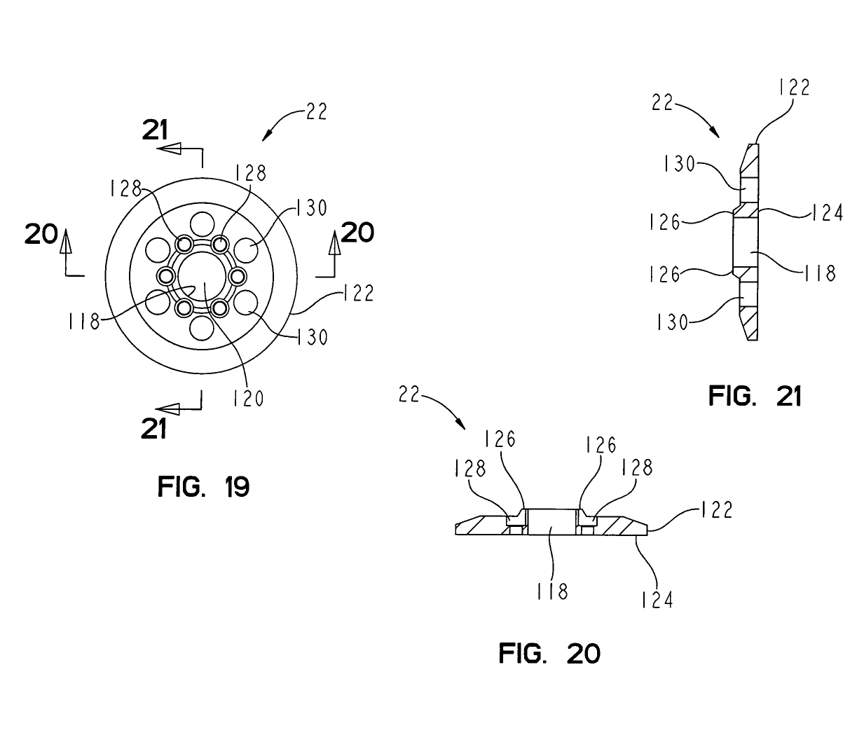

Referring to FIGS. 2 to 4, a pressure plate 22 is maintained in spaced relation to caliper 18 by a plurality fasteners such as bolts 38 and equal number of spacer sleeves 36. Referring to FIGS. 19 to 21, the pressure plate 22 is disc-shaped with an axially extending circumferential inner wall 118 defining a central aperture 120 and an axially extending circumferential outer wall 122. The pressure plate has radially extending planar surface 124 which contacts the backing plate 134 of the second of a pair of brake discs 132 when the disc brake assembly 10 is in the engaged position.

Opposite from pressure plate planar surface 124 is an axially extending flange 126 around central aperture 118. Flange 126 contacts the stationary outer race of bearing 42 when the disc brake assembly 10 is in the assembled condition (FIG. 5).

The pressure plate 22 includes a plurality of circumferentially spaced untapped bores 128 radially outward from the central aperture 120 for receiving bolts 38 and a plurality of circumferentially spaced intermediate vent holes 130. The untapped bores 128 of the pressure plate 22 correspond to the circumferentially spaced threaded bores 56 of caliper 18.

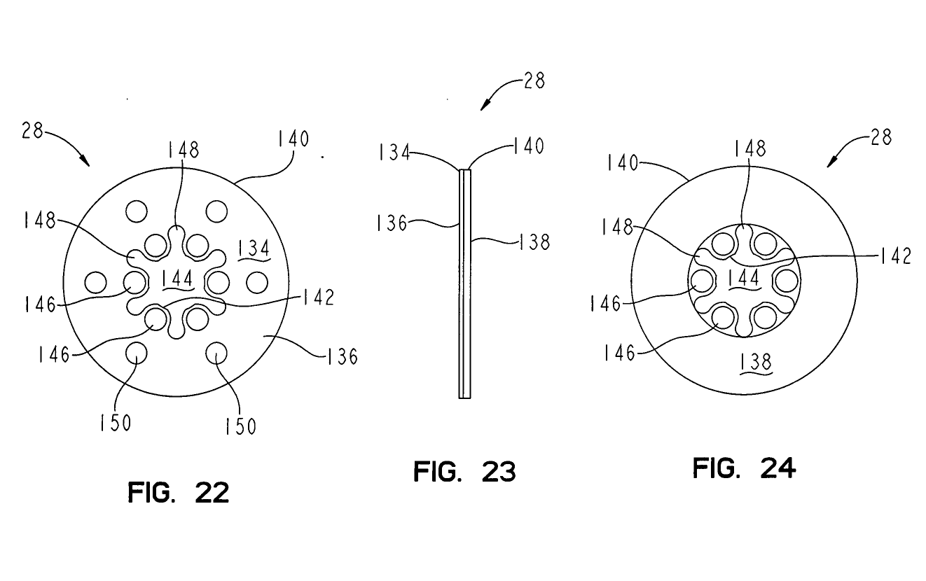

Referring to FIGS. 2-4, the disc brake assembly 10 also includes a pair of brake discs 24 and 28. Brake disc 28 is representatively shown in FIGS. 22 to 24. Brake disc 24 mirrors brake disc 28 so further description of brake disc 24 is not necessary. Brake disc 28 includes backing plate 134 with a radially extending planar surface 136 and a planar friction surface 138. Brake disc 28 also includes has an outer circumferential wall 140 and inner perimetral wall 142 defining a central aperture 144 which defines a plurality of circumferentially spaced slots 146. Brake disc 28 is adapted for axial movement along spacer sleeves 36 (FIG. 5). More particularly, brake disc 28 includes a plurality of circumferentially spaced bores 146 radially outboard from inner perimetral wall 142 defining central aperture 144 and intermediate to slots 146. The circumferentially spaced bores 146 of brake disc 28 correspond to the circumferentially spaced untapped bores 128 of pressure plate 22 and an also corresponded to the circumferentially spaced threaded bores 56 of caliper 18 (FIGS. 2-4).

The backing plate 134 also includes a plurality of circumferentially spaced openings 150 radially out board from the circumferentially spaced slots 148 and from intermediate circumferentially spaced bores 146. These openings 150 receive friction material when the friction material is applied to the backing plate 134 to form planar friction surface 138. The friction material composition and its application process are proprietary to the manufacturer. When applied to form the frictional planar surface 138, the friction material which makes it way into openings 150 assists in resisting shear forces at the bond between the planar friction surface 138 and backing plate 134 when brake disc assembly 10 is engaged.

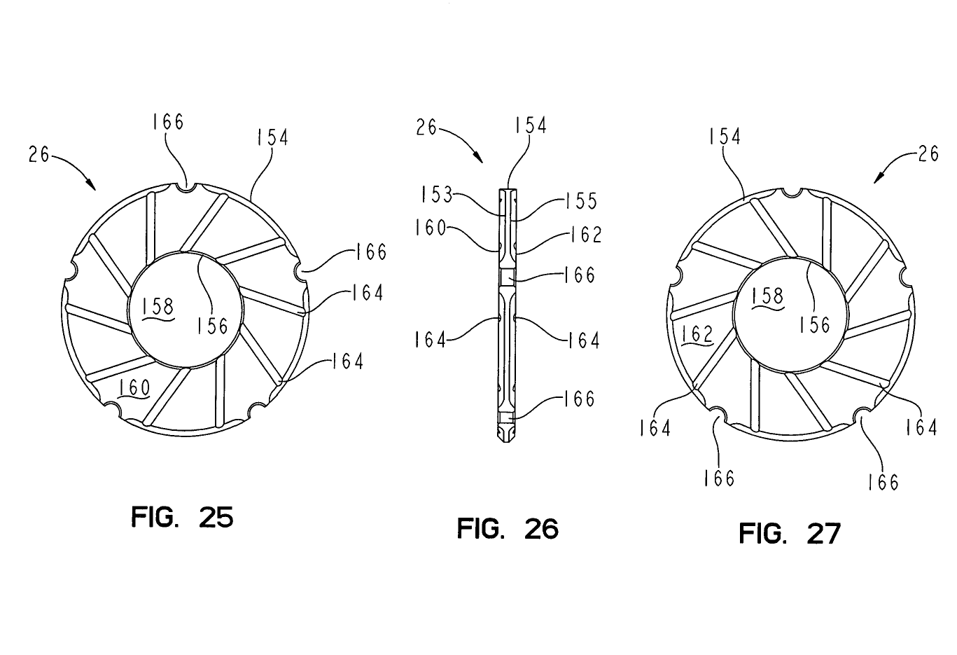

As seen in FIGS. 2 to 4, a rotor 26 is disposed between the pair of brake discs 24 and 28 and in the space defined by the pressure plate 22 and caliper 18. As shown in FIGS. 25 through 27, the rotor 26 includes a circumferential perimetral outer wall 154, a circumferential perimetral inner wall 156 defining a central aperture 158, and a pair of opposed radially extending planar surfaces 160 and 162.

Rotor planar surfaces 160 and 162 each include a plurality of generally radially extending grooves 164 which aid in heat dissipation, degassing, and removal of friction material dust and debris as the brake disc planar friction surfaces 138 of the brake discs 24 and 28 wear during normal operation.

As shown in FIG. 26, the radially extending grooves 164 of the first planar surface 160 of the rotor 26 mirror the radially extending grooves 164 of the second planar surface 162. Optionally, alternate opposing grooves 164 may be omitted from each planar surface thereby increasing the minimum thickness the rotor 26 at any one groove 164 and thereby increasing the strength of the rotor 26.

To aid in the entry of ambient air into and exit of heated air from the spaced defined by the pressure plate 22 and the caliper 18, planar surfaces 160 and 162 of the rotor 26 include bevels 153 and 155 at the intersection of planar surfaces 160 and 162 and the rotor outer circumferential perimetral wall 154.

The rotor 26 is adapted to rotate with vehicle wheel 14 (FIG. 1). More specifically, as seen in FIGS. 25 to 27, the outer circumferential wall 154 of the rotor 26 includes a plurality of semi-circular notches 166 which receive and correspond to a plurality of drive pins 40 (FIG. 2) fixedly attached to rotor hat 20 (FIG. 2) which in turn is fixedly mounted to a vehicle wheel 14 so as to rotate with the wheel 14 (FIG. 1).

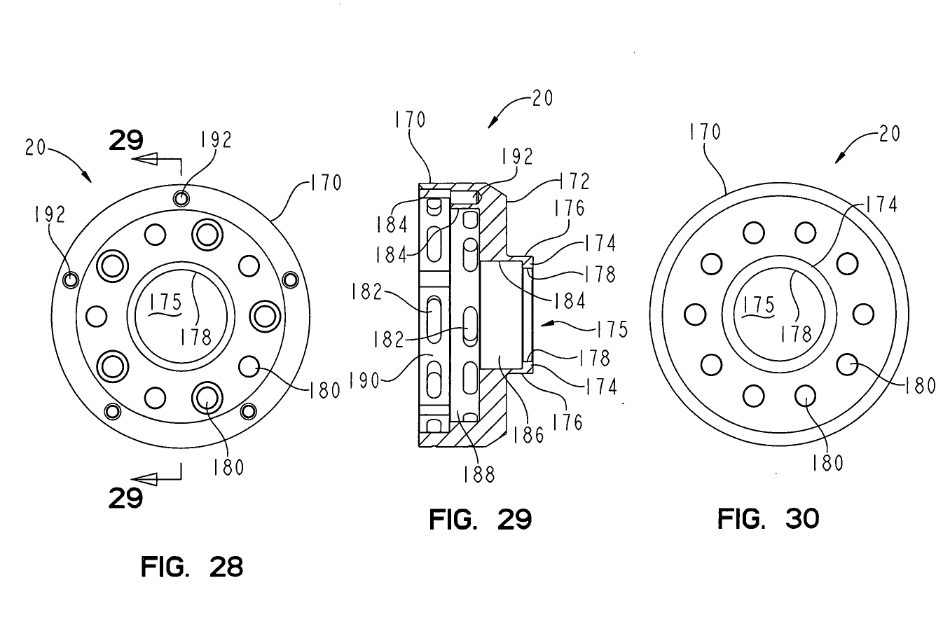

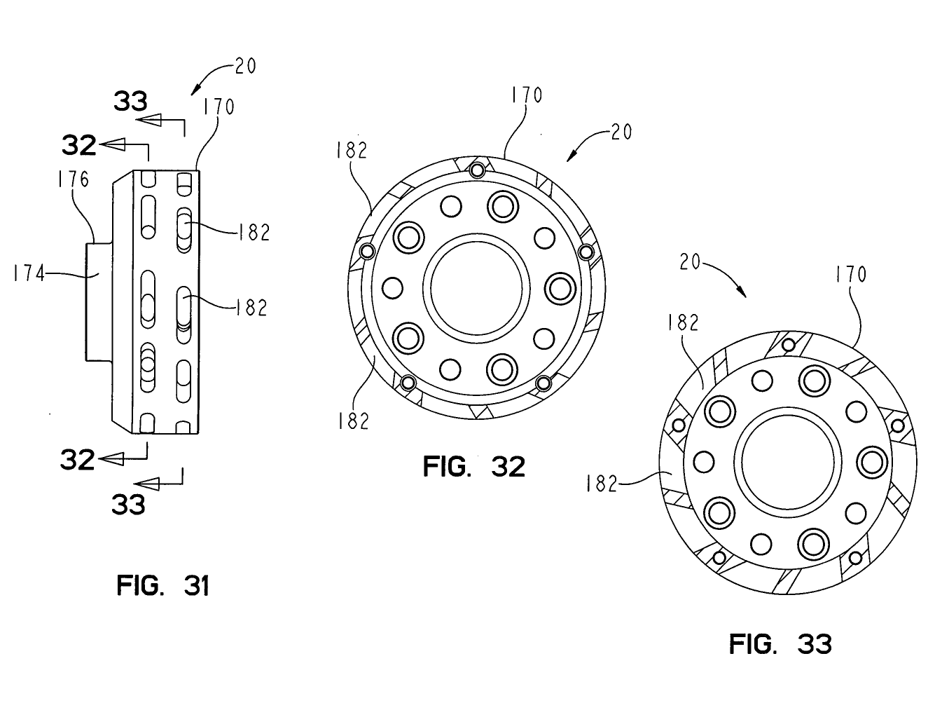

Referring to FIGS. 2 to 4, a rotor hat 20 houses the brake discs 24 and 28, rotor 26, and pressure plate 22. As shown in FIGS. 28 to 33, the rotor hat 20 is generally cup-shaped with an axially extending circumferential perimetral outer wall 170, a radially extending annular side wall 172, and an axially extending flange 174. The flange outer circumferential wall 176 aids in coaxially locating rotor hat 20 with respect to a wheel 14 when the rotor hat is fixedly attaching to the wheel 14 (FIG. 1). The axially extending flange 174 also includes a radially extending lip 178 which defines a central opening 175. The rotor hat radially extending annular side wall 172 includes a plurality of bores 180 for fixedly attaching the rotor hat 20 to a wheel 14 by fasteners such as bolts or screws (not shown). Optionally, these bores may be threaded or unthreaded to provide a range of options for mounting to rotor hat 20 to the wheel 14 (FIG. 1). As shown in FIGS. 31 to 33, the rotor hat circumferential wall 170 includes a plurality of vent holes 182 shown in two rows for the ingress of ambient air into the disc brake assembly 10 and egress of heated air and friction material dust and particles from the disc brake assembly 10. Returning to FIG. 29, the rotor has a circumferential inner wall 184 that is characterized by a series of three cylindrical chambers of varying diameters. The small outer cylindrical chamber 186 cooperates with flange lip 178 to house bearing 42 (FIG. 5). Intermediate cylindrical chamber 188 houses pressure plate 22 when the disc brake 10 is in the assembled condition (FIG. 5). The large inner cylindrical chamber 190 houses the rotor 20 and the pair of brake discs 24 and 28 (FIG. 5). Returning to FIGS. 28 and 29, extending wall 192 connecting the large inner chamber 190 and the intermediate chamber 188 includes a plurality of circumferentially spaced tapped bores 192 for fixedly mounting drive pins 40 into the rotor hat 20 (FIG. 2). These circumferentially spaced tapped bores 192 correspond to semicircular notches 166 of the rotor disc 26 (FIGS. 2 to 4).

As shown in FIG. 42, the drive pins 40 preferredly have threaded portion 196, smooth portion 198, and means for accepting a tool for rotation 200 such as an Allen wrench to install to drive pins 40 into rotor hat 20.

The disc brake assembly includes a plurality of cylindrical spacer sleeves 36, each of which includes a bore 204 for receiving the bolts 38. As shown in FIG. 41, each spacer sleeve 36 has two ends has a smooth outer surface 206 for sliding contact with rotor 22 and brake discs 24 and 28. As seen in FIG. 5, first end contacts the caliper 18, and a second end which contacts the pressure plate 22 when the disc brake assembly 10 is in the assembled condition, thereby maintaining a spaced relation between the caliper 18 and the pressure plate

Returning to FIGS. 2-5, to assemble the disc brake, seal rings 32 and 34 are placed into caliper inner and outer grooves 66 and 68, and annular piston 30 is disposed within caliper annular channel 58. A first brake disc 28, the rotor 26 and a second brake disc 24 are coaxially aligned with caliper 18 with spacer sleeves 36 by placing spacer sleeves into circumferentially spaced bores 146 of brake disc 24 (FIG. 22), through the central aperture 158 of rotor 26 (FIG. 25), and through the circumferentially spaced bores 146 of brake disc 28 (FIG. 22). Bolts 38 (FIG. 40) are inserted then inserted through the untapped bores 128 of pressure plate 21 and, through spacer sleeve bores 204 and bolts 38 are torqued into the corresponding circumferentially spaced threaded bores 56 of the caliper 18.

The central aperture 158 of rotor 26 is sized so that the inner perimetral wall 156 defining the central aperture 158 maintains a clearance with respect to the spacer sleeves 36 when the rotor 26 is aligned coaxially with the pressure plate 22 and caliper 18 and is thus free to rotate when driven by rotor hat 20 and drive pins 36.

Bearing 42 is installed into small outer chamber 186 of rotor hat 20.

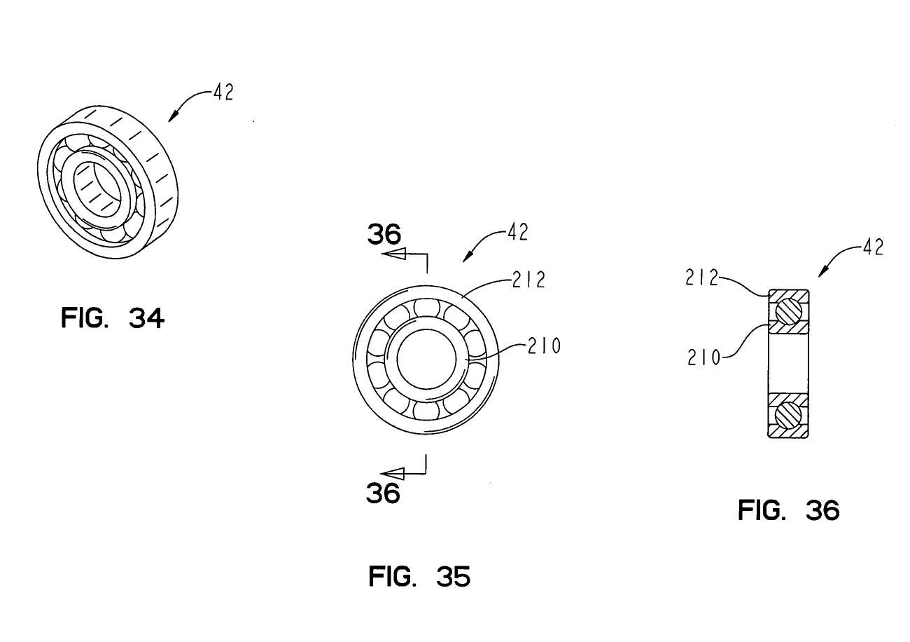

Bearing outer race 212 is in fixed contact with rotor hat small chamber 186 and lip 178, allowing the rotor hat 20 to rotate relative to the pressure plate 22. As shown in FIGS. 34 to 36, in the preferred embodiment of bearing 42 is a ball bearing having an inner race 210 and outer race 212. In the preferred embodiment, bearing 42 is a single row sealed ball bearing manufactured by ACOR, part number 304C3 that is 52 mm in outside diameter, with a one inch inside diameter, and a 21 mm thickness.

In the installed condition, rotor hat 20 is installed onto a wheel 14 by means of fasteners such as bolts or screws (not shown) through bores 180 (FIG. 28). The caliper 18, brake discs 24 and 28, and rotor 26 are assembled into chambers 188 and 190 of rotor hat 20 by aligning the drive pins 40 with rotor semicircular notches 166.

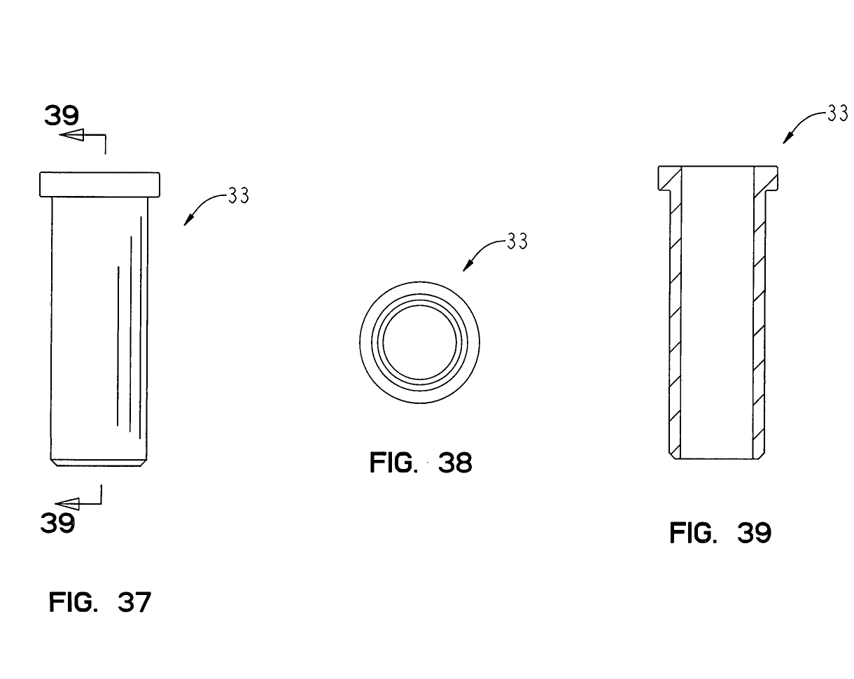

In the preferred embodiment, the disc brake assembly is constructed to accept a typical one inch diameter motorcycle dead axle (not shown). For smaller axles, an adapter sleeve 33 such as top hat bushing shown in FIGS. 37 to 39 may be used to adapter to disc brake assembly for use with smaller axles. Caliper spacers 31 illustratively shown in FIG. 43 may be used to maintain a spaced relationship between the caliper 18 and the fork tube 16, as well as between the rotor hat 20 and a wheel 14. FIG. 5 illustrated depicts and disc brake assembly with a caliper spacer 31 and 33 installed.

Once assembled, the disc brake is placed between the wheel 14 and for tube 16 and the dead axle (not shown) is inserted through the central apertures of the disc brake assembly. The assembly is maintained in operation position and condition by the fasteners (not shown) which attach the dead axle to the fork tubes 14.

Movement of the vehicle causes the rotor hat 20 to rotate with the wheel 14, thereby turning rotor 26 via drive pins 40. To actuate the brake assembly, fluid pressure is introduced into caliper chamber 100 thereby axially displacing annular piston 30 into contact with the backing plate 134 of the first rotor disc 28. In turn, the planar friction surface 138 of first brake disc 28 frictionally engages planar surface 160 of rotor 26 and causes rotor 26 to move axially leftward as viewed in FIG. 5 so that second planar surface 162 of rotor 26 makes frictional contact with the planar friction surface 138 of second brake disc 24. Pressure plate planar surface 124 provides to reaction force to the actuating forces generated by annular piston 30. As the actuating force is increased, the rotational kinetic energy of the rotor 26 and wheel 14 is dissipated as heat, thereby slowing the combination.

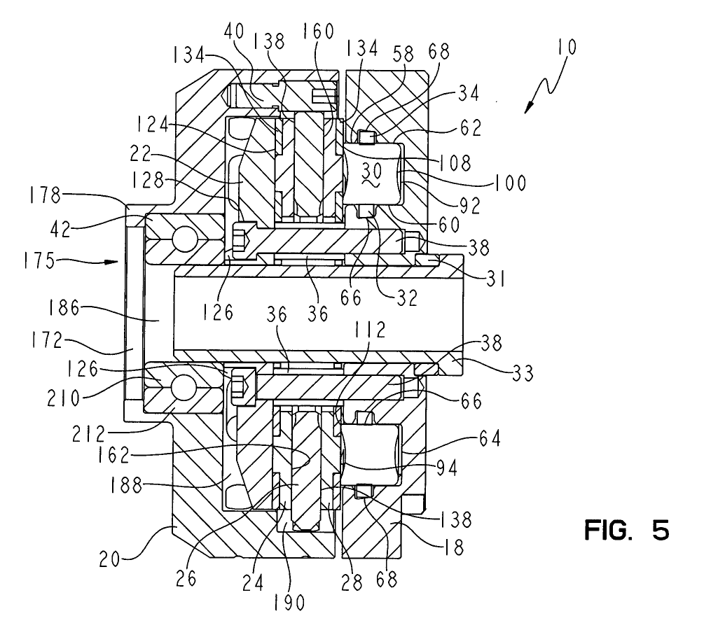

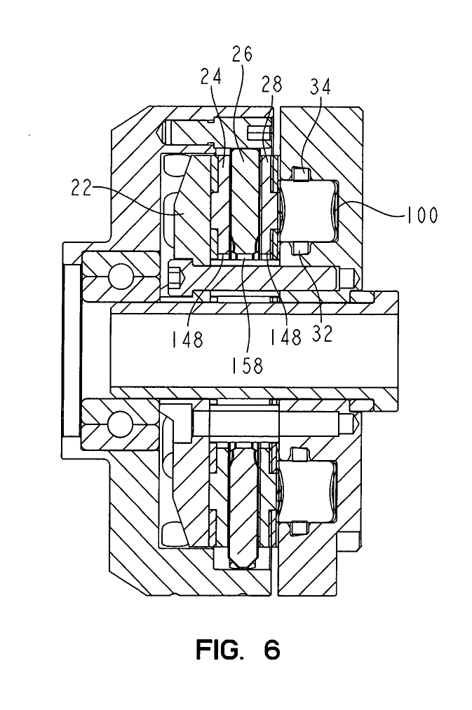

FIG. 6 shows the disc brake assembly 10 in the disengaged position. The brake assembly 10 is disengaged by releasing fluid pressure from chamber 100. When fluid pressure is released, the stored energy of the seal rings 32 and 88 causes annular piston 30 to retract into caliper channel 58, thereby releasing the brake discs 24 and 28 from frictional contact from the brake rotor 26, and allowing brake discs 24 and 28, and rotor 26 to displace to the right as viewed in FIG. 6.

As energy is dissipated by friction contact of the brake discs 24 and 28 with rotor 26, the air in the spaced defined by the pressure plate 22 and caliper 18 can become heated. Such heated air can escape from the space via slots 148 of the brake discs 24 and 28, the vent holes 130 of the pressure plate 22 (FIGS. 19 and 21) and the central aperture 158 of the brake rotor 26. Heated air can then exit the disc brake assembly 10 through the vent holes 182 of the outer circumferential wall 170 of the rotor hat 20 (FIG. 31)

We claim:

1. A disc brake assembly for a vehicle comprising:
a caliper secured to a non-rotating portion of a vehicle, said caliper having a central aperture, a plurality of circumferentially spaced threaded bores radially outward from said central aperture, and an annular channel radially outward from said circumferentially spaced threaded bores;
an annular piston disposed within said annular channel, said annular piston having a central aperture, an inner wall and an outer wall, wherein said annular piston outer wall cooperates with the caliper annular channel to define a chamber;
a means for communicating hydraulic or pneumatic pressure to said chamber;
a pressure plate fixedly connected to said caliper, thereby defining a space between the pressure plate and the caliper, said pressure plate having a central aperture, a planar surface, and an opposing flanged surface;
a first brake disc having a central aperture, a backing plate, and an opposing planar friction surface;
a second brake disc having a central aperture, a backing plate, and an opposing planar friction surface;
a rotor having a central aperture, an outer perimetral wall, including a plurality of notches, a first planar surface, and a second planar surface;
wherein said first brake disc, said rotor and said second brake disc are disposed within the space defined by the pressure plate and the caliper, said first brake disc and the planar friction surface of the second brake disc mounted for engagement with the first planar surface and second planar surface, respectively, of said rotor;
a means for mounting for axial movement said first brake disc and said second brake disc from and toward said pressure plate planar surface;
a means for mounting the rotor for axial movement from and toward the pressure plate planar surface;
a housing fixedly connected to a rotating structure of the vehicle, said housing having an inner chamber which houses the pressure plate, the first and second brake discs, and the rotor, said housing having a central aperture an outer circumferential wall and including a plurality of drive pins for association with said rotor notches to rotate the rotor.

2. The disc brake assembly of claim 1, wherein the annular piston inner wall includes a plurality of protrusions to associate with the first brake disc backing plate.

3. The disc brake assembly of claim 1, wherein the annular piston outer wall is an annular trough.

4. The disc brake assembly of claim 2, wherein the annular piston inner wall includes a plurality of protrusions with intermediate notches

5. The disc brake assembly of claim 1, wherein the caliper annular channel includes a seal ring groove.

6. The disc brake assembly of claim 5, wherein the caliper annular channel includes at least two seal ring grooves.

7. The disc brake assembly of claim 5 with a seal ring disposed within said seal ring groove.

8. The disc brake assembly of claim 6 with a seal ring disposed in each of said seal ring grooves.

9. The disc brake assembly of claim 1, wherein the said brake disc backing plates include a plurality of openings for receiving friction material.

10. The brake disc assembly of claim 1, wherein the pressure plate includes a plurality of vent holes.

11. The brake disc assembly of claim 1, wherein the first and second brake discs each include a plurality of circumferentially spaced bores corresponding to the caliper circumferentially spaced threaded bores, and the means for mounting said brake discs for axial movement is a plurality of spacer sleeves.

12. The disc brake assembly of claim 1, wherein the housing outer circumferential wall includes a plurality of vent holes.

13. The disc brake assembly of claim 11, wherein the central aperture of said first and second brake discs include a plurality of slots intermediate to said circumferentially spaced bores.

14. The disc brake assembly of claim 1, wherein the pressure plate is fixedly connected to the caliper with bolts.

15. A disc brake assembly for a two-wheeled vehicle wheel comprising:
a caliper secured to a two wheeled vehicle fork tube, said caliper having a central aperture and an annular channel radially outward from said central aperture;
an annular piston disposed within said annular channel, said annular piston having an outer side wall and inner side wall, wherein the outer side wall cooperates with said annular channel to define a chamber;
a pressure plate fixedly connected to said caliper, thereby defining a space between the pressure plate and caliper, said pressure plate having a central aperture, a planar surface, and opposing flanged surface;
a first brake disc having a planar friction surface;
a second brake disc having a planar friction surface;
a rotor disc having an outer perimetral wall including a plurality of notches, a first planar surface, and a second planar surface, wherein said first brake disc, said rotor, and said second brake disc are disposed with the space defined by the pressure plate and caliper, and wherein the planar friction surface of said first brake disc and the planar friction surface of the second brake disc are mounted for engagement with the first planar surface and second planar surface, respectively, of said rotor;
a means for mounting said first brake disc and said second brake disc for axial movement form and toward said pressure plate;
a bearing;
a housing fixedly connected to a two-wheeled vehicle wheel, said housing having an inner chamber which houses the pressure plate, first and second brake discs, and the rotor, and said housing having a central aperture for receiving said bearing, an outer circumferential wall, and including connecting means to rotate the rotor.

16. The disc brake assembly of claim 15, wherein the annular piston inner wall includes a plurality of protrusions to associate with the first brake disc backing plate.

17. The disc brake assembly of claim 15, wherein the annular piston outer side wall is an annular trough.

18. The disc brake assembly of claim 16, wherein the annular piston inner side wall includes a plurality of protrusions with intermediate notches

19. The disc brake assembly of claim 17, wherein the caliper annular channel includes at least two seal ring grooves.

20. The disc brake assembly of claim 19 with a seal ring disposed in each of said seal ring grooves.

21. The disc brake assembly of claim 15, wherein the said brake disc backing plates include a plurality of openings for receiving friction material.

22. The brake disc assembly of claim 15, wherein the pressure plate includes a plurality of vent holes.

23. The brake disc assembly of claim 15, wherein the first and second brake discs each include a plurality of circumferentially spaced bores corresponding to the caliper circumferentially spaced threaded bores, and the means for mounting said brake discs for axial movement is a plurality of spacer sleeves.

24. The disc brake assembly of claim 15, wherein the housing outer circumferential wall includes a plurality of vent holes.

25. The disc brake assembly of claim 23, wherein the central aperture of said first and second brake discs include a plurality of slots intermediate to said circumferentially spaced bores.

26. The disc brake assembly of claim 15, wherein the pressure plate is fixedly connected to the caliper with bolts.
